(19) United States
(12) Patent Application Publication
(10) Pub. No.: US 2013/0154396 A1
(43) Pub. Date: Jun. 20, 2013

(54) VOICE COIL MOTOR

(71) Applicant: TAI-HSU CHOU, Tu-Cheng (TW)

(72) Inventor: TAI-HSU CHOU, Tu-Cheng (TW)

(73) Assignee: HON HAI PRECISION INDUSTRY CO., LTD., Tu-Cheng (TW)

(21) Appl. No.: 13/533,030

(22) Filed: Jun. 26, 2012

(30) Foreign Application Priority Data
Dec. 19, 2011 (TW) 100147110

(51) Int. Cl. H02K 41/035

(52) U.S. Cl. 310/12.16

(57) ABSTRACT

A voice coil motor (VCM) includes a shell, a frame, an elastic member, a moving unit, and a plurality of magnetic members. The shell includes a top plate and sidewall extending from the top plate. The frame is received in the shell and mounted to the top plate. The elastic member is mounted to the frame. The moving unit is received in the shell and includes a lens retainer and coils wrapped around the lens retainer. The frame and the elastic member are arranged on an end surface of the lens retainer. Each of the magnetic members is directly mounted to the sidewall and positioned between the sidewall and the moving unit.

### BACKGROUND

1. Technical Field

The present disclosure relates to means of focusing, and particularly to a voice coil motor.

2. Description of Related Art

Voice coil motors (VCMs) may be used as a means of focusing in camera modules. A VCM usually includes a rack, a shell housing the rack, a moving unit received in the rack and wound with coils, and magnets positioned on the rack. In use, a lens can be held in the moving unit and driven to move along with the moving unit for focusing when applying current to the coils and magnetic driving forces between the magnets and the coils are generated. However, to accommodate the magnets, the rack must have a bulky body, adversely affecting the miniaturization of the VCM.

Therefore, it is desirable to provide a voice coil motor which can overcome the above-mentioned problems.

### BRIEF DESCRIPTION OF THE DRAWINGS

Many aspects of the present voice coil motor can be better understood with reference to the following drawings. The components in the drawings are not necessarily drawn to scale, the emphasis instead being placed upon clearly illustrating the principles of the present voice coil motor. Moreover, in the drawings, like reference numerals designate corresponding parts throughout the several views.

FIG. 1 is an exploded view of a voice coil motor in accordance with an exemplary embodiment.

FIG. 2 is similar to FIG. 1, but is viewed from another angle.

FIG. 3 is a partially assembled view of the voice coil motor shown in FIG. 2, which is in a first stage of assembly.

FIG. 4 is a partially assembled view of the voice coil motor of FIG. 2, which is in a second stage of assembly.

FIG. 5 is a fully assembled view of the voice coil motor of FIG. 2.

### DETAILED DESCRIPTION

Embodiments of the present voice coil motor will be described with reference to the drawings.

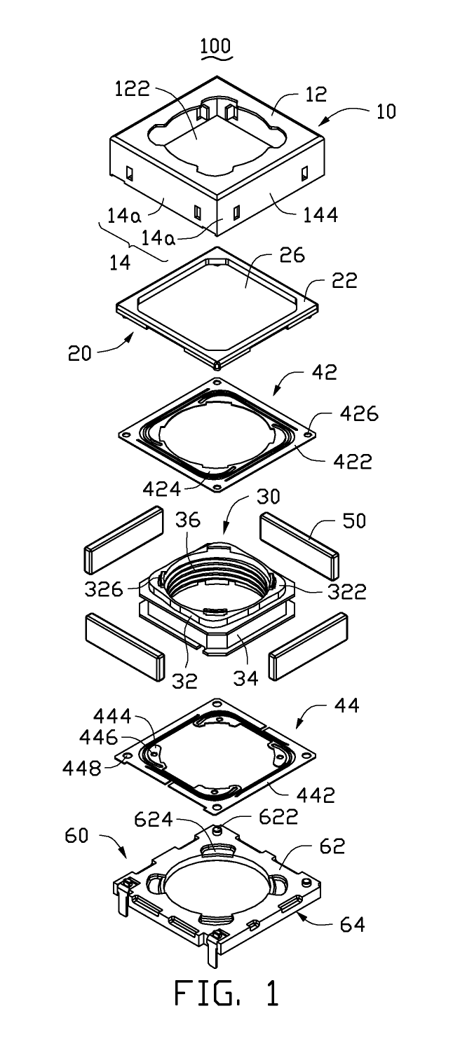

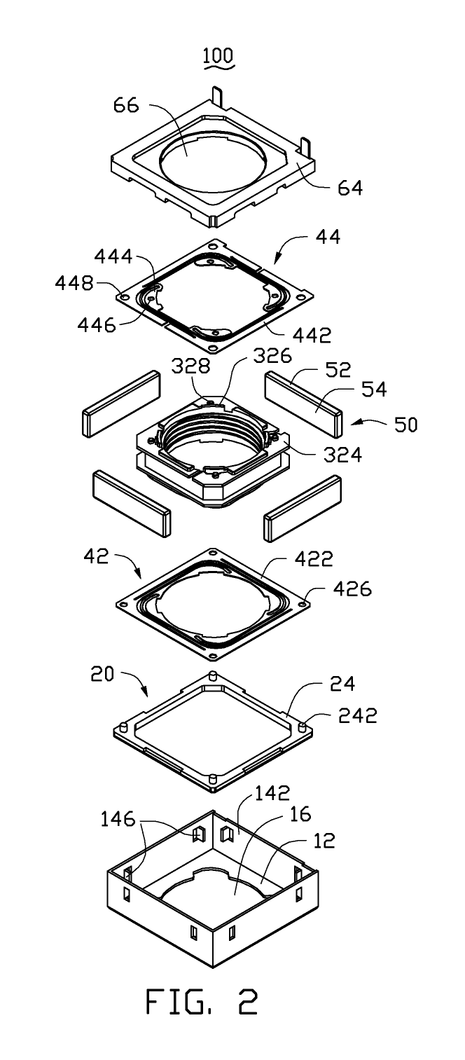

Referring to FIGS. 1 and 2, a VCM 100 in accordance with an exemplary embodiment is provided. The VCM 100 includes a shell 10, a frame 20, a moving unit 30, a first elastic member 42, a second elastic member 44, four magnetic members 50, and a base 60.

The shell 10 is made of electrically conductive materials, such as a conductive alloy, a conductive polymer, or conductive glass, which provides electro magnetic interference (EMI) shielding for the VCM 100. In this embodiment, the shell 10 is made of ferro-nickel alloy. The shell 10 includes a top plate 12 and a sidewall 14 perpendicularly extending from the periphery of the top plate 12. The top plate 12 is substantially square and defines a through hole 122. The sidewall 14 includes four sub-sides walls 14a. Each of the four sub-sidewalls 14a extends from a side of the top plate 12. Each sub-sidewall 14a includes an inner surface 142 and an outer surface 144. The top plate 12 and the four sub-sidewalls 14a cooperatively form a receiving space 16. By a stamping process, each sub-sidewall 14a forms a pair of limiting portions 146. The pair of limiting portions 146 are generally rectangular and perpendicularly extend from the inner surface 142 toward the receiving space 16.

In alternative embodiments, the shells 10 and each pair of limiting portions 146 are separately manufactured using a same material. Then each pair of limiting portions 146 can be connected to an inner surface 142 by a welding process.

The frame 20 is substantially square, corresponding to the top plate 12 in shape. The frame 20 is made of plastic and includes a contact surface 22 and a mounting surface 24 opposite to the contact surface 22. The frame 20 defines a center hole 26 passing through the contact surface 22 and the mounting surface 24. The center hole 26 corresponds to the through hole 122. The frame 20 further includes four first alignment portions 242 extending from four corners of the mounting surface 24.

The moving unit 30 includes a lens retainer 32 and coils 34 wrapped around the lens retainer 32. The lens retainer 32 is generally tubular and includes a first end surface 322, a second end surface 324 opposite to the first end surface 322, a plurality of clamping portions 326, and four second alignment portions 328. Some of the clamping portions 326 extend from the first end surface 322, and the remainder of the clamping portions 326 extend from the second end surface 324. The second alignment portions 328 extend from four corners of the second end surface 324. The lens retainer 32 defines a receiving hole 36 passing through the first end surface 322 and the second end surface 324 for receiving a lens (not shown).

The first elastic member 42 is stamped from of a metal sheet and includes a first main portion 422, which has a shape of substantially a rectangular frame, and four first elastic branches 424 extending from the first main portion 422 along the inner periphery of the first main portion 422. The first main portion 422 defines four first alignment holes 426. Each first alignment hole 426 corresponds to a first alignment portion 242.

The second elastic member 44 is also stamped from a metal sheet and includes a second main portion 442, which is substantially a rectangular frame in shape, and four second elastic branches 444 extending from the second main portion 442 along the inner periphery of the second main portion 442. Each second elastic branch 444 defines a second alignment hole 446. Each second alignment hole 426 corresponds to a second alignment portion 328. The second main portion 442 defines four third alignment holes 448 generally at four corners of the second main portion 442.

The four magnetic members 50 are permanent magnets. Each magnetic member 50 is cuboid and includes two ends, 52 and 54. A distance between the two ends 52 and 54 corresponds to a distance between the pair of the limiting portion 146 of a sub-sidewall 14a.

The base 60 includes a top surface 62 and a bottom surface 64 opposite to the top surface 62. The base 60 defines a circular light passing hole 66 extending through the top surface 62 and the bottom surface 64. The base 62 further includes four third alignment portions 622. Each third alignment portion 622 corresponds to a respective one of the third alignment holes 446. The top surface 62 defines four indentions 624. The four indentions 624 are uniformly arranged around the light passing hole 66 and are in communication with the light passing hole 66.

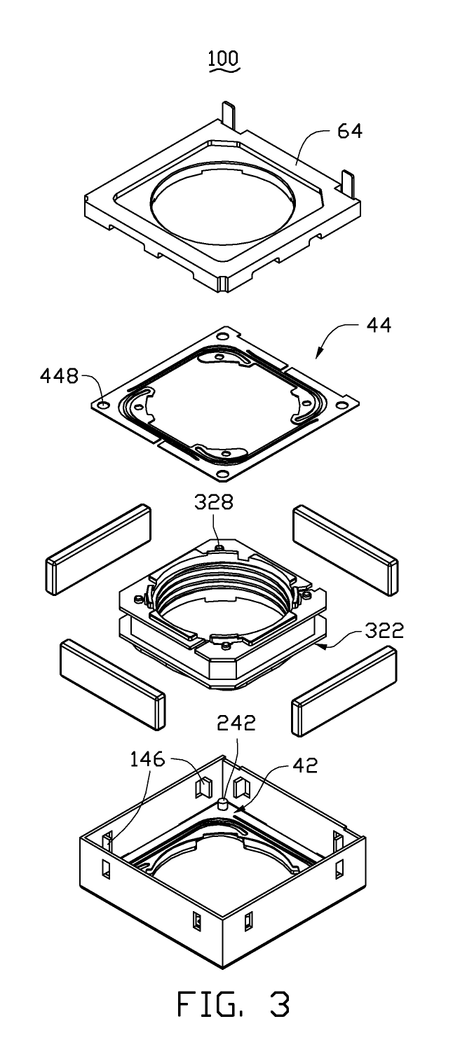

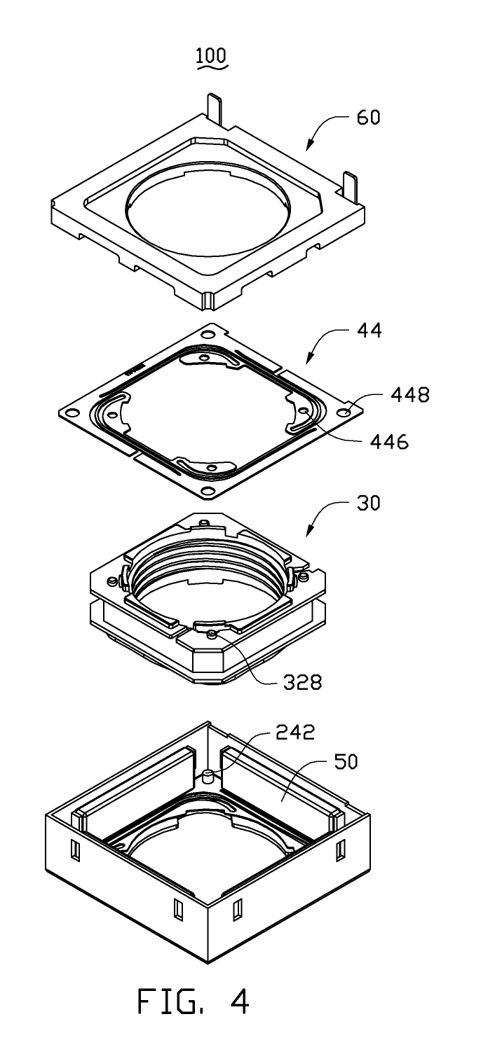

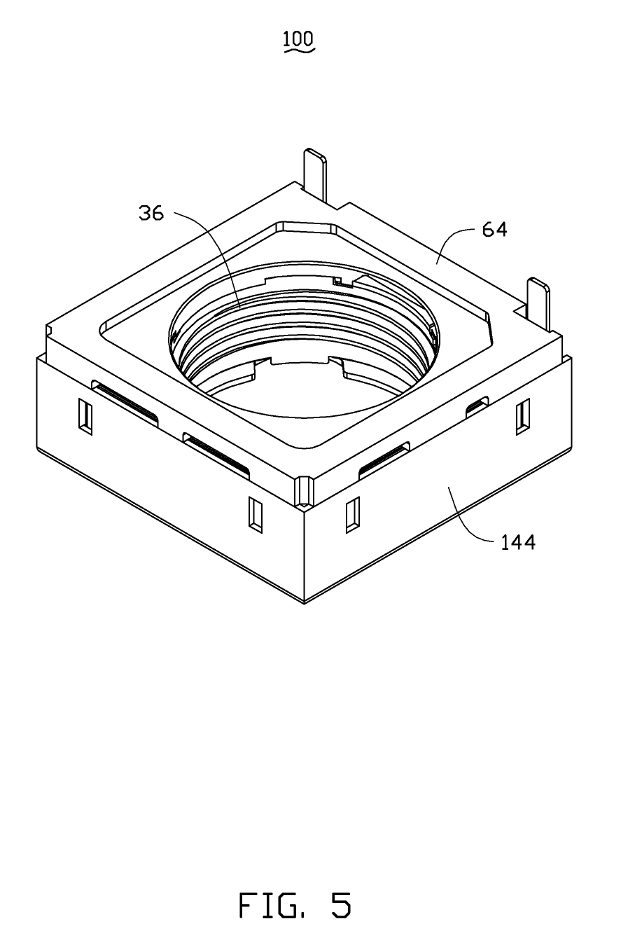

Referring to FIGS. 3 to 5, in assembling, each sub-sidewall 14a does not form the pair of limiting portions 146, the frame 20 is accommodated in the receiving space 16 with the contact surface 22 being attached and adhered to the top plate 22. The first elastic member 42 is mounted to the mounting surface 24 of the frame 20 with each first alignment portion 242 passing through a respective one of the first alignment holes 426. The first elastic member 42 is adhesively attached to the mounting surface 24 of the frame 20. Then the pair of limiting portions 146 are formed on each sub-sidewall 14a by stamping. Each magnetic member 50 is positioned between and clipped by the pair of limiting portions 146 of a sub-sidewall 14a. Each magnetic member 50 is directly adhering to an inner surface 142 by adhesive.

The moving unit 30 is received in the receiving space 16. Each magnetic member 50 is positioned between a sub-sidewall 14a and the moving unit 30 and faces the moving unit 30. The clamping portions 326 of the first end surface 322 of the lens retainer 32 clamp the first elastic branches 424. The second elastic member 44 is received in the receiving space 16 and attached on the second end surface 324 of the lens retainer 32. The clamping portions 326 of the second end surface 324 of the lens retainer 32 clamp the second elastic branches 444. Each second alignment portion 328 passes through a respective one of the second alignment holes 446. The base 60 is fixed to the sidewall 14 of the shell 10 by adhesive. Each third alignment portion 622 passes through a respective one of the third alignment holes 448. After assembly, each second alignment portion 328 passes through a second elastic branch 444 and is received in an indention 624. Each indention 624 increases the space available for a second elastic branch 444.

In this embodiment, because each magnetic member 50 is directly mounted to an inner surface 142, the frame 20 and the first elastic member 42 are arranged on the first end surface 322 of the lens retainer 32, the structure of the VCM 100 is simplified to such an extent that the volume of the VCM 100 is significantly miniaturized.

In this embodiment, the frame 20 can be quickly aligned with the first elastic member 42 by utilizing the first alignment portions 242 and the first alignment holes 426, the moving unit 30 can be quickly aligned with the second elastic member 44 by utilizing the second alignment portions 328 and the second alignment holes 446, and the base 60 can be quickly aligned with the second elastic member 44 by utilizing the third alignment portions 662 and the third alignment holes 448 when assembling the VCM 100.

In alternative embodiment, the number of the first alignment portions 242, the second alignment portions 328, or the third alignment portions 662 can be at least one rather than being limited to four. The number of first alignment holes 426, second alignment holes 446, and third alignment holes 448 will correspond to the number of first alignment portions 242, second alignment portions 328, and third alignment portions 662.

In alternative embodiments, each sub-sidewall 14a does not include the pair of limiting portions 146. Each magnetic member 50 is fixed to a predetermined position of an inner surface 142.

In alternative embodiments, the shell 10 can be hollow and cylindrical and include a curved sidewall. Accordingly, the frame 20, the first elastic member 42, and the second elastic member 44 will be circular. Each magnetic member 50 will be curved. The number of the magnetic members 50 is not limited to four.

The above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A voice coil motor (VCM), comprising:
a shell comprising a top plate and a sidewall extending from the top plate, the top plate and the sidewall cooperatively defining a receiving space;
a frame received in the receive space and mounted on the top plate;
a first elastic member mounted on the frame;
a moving unit received in the receiving space, the moving unit comprising a lens retainer and coils wrapped around the lens retainer, the lens retainer comprising a first end surface; and
a plurality of magnetic members;
wherein the frame and the first elastic member are arranged on the first end surface of the lens retainer, each of the magnetic members is directly mounted on the sidewall and positioned between the sidewall and the moving unit.

2. The VCM of claim 1, wherein the top plate is substantially square, the sidewall comprises four sub-sidewalls perpendicularly extending form four sides of the top plate, the VCM comprises four of the magnetic members, each of the magnetic members is mounted on a corresponding one of the sub-sidewalls.

3. The VCM of claim 2, wherein the shell is made of ferro-nickel alloy, each sub-sidewall comprises a pair of limiting portions extending to the receiving space, each magnetic member is positioned between the pair of the limiting portions of the corresponding sub-sidewall.

4. The VCM of claim 2, wherein the frame comprises a contact surface, a mounting surface opposite to the contact surface, and a plurality of first alignment portions extending from the mounting surface; the contact surface is attached and adhered to the top plate; the first elastic member defines a plurality of first alignment holes, each first alignment portion passes through a respective one of the first alignment holes.

5. The VCM of claim 1, wherein the lens retainer further comprises a second end surface and a plurality of second alignment portions extending from the second end surface, the VCM further comprises a second elastic member, the second elastic member is received in the receiving space and defines a plurality of second alignment holes, each second alignment portion passes through a respective one of the second alignment holes.

6. The VCM of claim 5, wherein the VCM further comprises a base, the base is mounted on the sidewall, the base comprise a top surface, a bottom surface opposite the top surface, and a plurality of third alignment portions extending from the top surface, the second elastic member further defines a plurality of third alignment holes, each third alignment portion passes through a respective one of the third alignment holes.

7. The VCM of claim 6, wherein the base defines a light passing hole and a plurality of indentions, the light passing hole extends through the top surface and the bottom surface, the indentions are uniformly arranged around and are in communication with the light passing hole, each second alignment portion is received in a respective one of the indentions.

8. A VCM, comprising:
a shell comprising a top plate and a sidewall perpendicularly extending from the top plate;
a frame received in the shell and mounted on the top plate;
a first elastic member mounted on the frame;
a moving unit received in the shell, the moving unit comprising a lens retainer and coils wrapped around the lens retainer, the lens retainer comprising a first end surface, the frame and the first elastic member being arranged on the first end surface; and
a plurality of magnetic members, each of the magnetic members being directly mounted on the sidewall and positioned between the sidewall and the moving unit.

9. The VCM of claim 8, wherein the top plate is substantially square, the sidewall comprises four sub-sidewalls perpendicularly extending form four sides of the top plate, the VCM comprises four of the magnetic members, each of the magnetic members is mounted to a corresponding one of the sub-sidewalls.

10. The VCM of claim 9, wherein the shell is made of ferro-nickel alloy, each sub-sidewall forms a pair of limiting portions extending to the moving unit, each magnetic member is positioned between the pair of the limiting portion.
